(19) United States
(12) Patent Application Publication
(10) Pub. No.: US 2019/0087779 A1
(43) Pub. Date: Mar. 21, 2019

(54) DYNAMIC ROUTING SYSTEMS AND METHODS

(71) Applicant: Flexport, Inc., San Francisco, CA (US)

(72) Inventors: Brian CAMEROS, San Francisco, CA (US); Sanne MANDERS, Portland, OR (US)

(21) Appl. No.: 16/130,738

(22) Filed: Sep. 13, 2018

Related U.S. Application Data
(60) Provisional application No. 62/560,603, filed on Sep. 19, 2017.

(51) Int. Cl. G06Q 10/08

(52) U.S. Cl. CPC G06Q 10/08355; G06Q 10/0831; G06Q 10/0833

(57) ABSTRACT

This disclosure relates to dynamic routing of mass after the mass has left the origin or otherwise entered the transportation process. In particular, this disclosure relates to systems and methods for changing the destination, route, or timeline of mass, either in its entirety or via splitting and rerouting the mass as smaller portions.

### CROSS REFERENCE TO OTHER RELATED APPLICATIONS

This application claims benefit under 35 U.S.C. 119(e) of U.S. Provisional Application No. 62/560,603 filed Sep. 19, 2017, which is hereby incorporated by reference in its entirety.

### TECHNICAL FIELD

This disclosure relates to the freight shipping industry. In particular, this disclosure relates to dynamically routing mass while the mass is in transport.

### BACKGROUND

The freight shipping industry involves moving mass from one location to another. Often, larger quantities of mass require the need for ships, trucks, containers, etc. Given, the growing global economy, the freight shipping industry is growing rapidly. The rise of e-commerce creates customer expectations that products will arrive soon after a transaction. Accordingly, the global shipping market increasingly demands quick turnaround. Thus, competing in today's global shipping and transit market requires the ability to quickly react to the changing demand and the real-time needs of shippers. However, the freight shipping industry still relies on antiquated technology that does not account for the rapid, real-time pace of today's marketplace.

Purchase orders are different for demand planning than supply planning. Demand planning refers to managing and planning products for customer demand. Supply planning refers to managing and planning the inventory to meet customer demand. In other words, balancing the expected customer interest with inventory supply. A purchase order is a document between a supplier and buyer detailing a purchase. In one instance, a company is a purchaser and in another a seller. Companies know the amount of resources needed to keep their inventory in stock, but they do not know the amount of product they will sell. This is a growing issue with social media and a growing e-commerce market increasingly providing opportunities for businesses to develop and grow.

The consolidation/deconsolidation process of a container and transloading at a distribution center is another issue. The traditional business model takes days to breakdown a container into the individual shipments, e.g., re-labeling, organizing, shipping, etc. This process takes an unnecessary amount of time, requires a large work force, and results in slowing moving goods.

There exists a need for quick turnaround of shipments from one location to another. There exists a need for rerouting shipments to skip a distribution center and be directed straight towards a final consignee. There exists a need for quicker consolidation/deconsolidation of shipments. There exists a need for end to end visibility of shipments.

### BRIEF DESCRIPTION OF THE DRAWINGS

FIG. 1 is an illustrative flow chart showing how the systems and methods disclosed herein can be used for rerouting mass.

FIG. 2 is an illustrative example of a Cargo Ruler as presented on a display means presenting Vessel 207 leaving Destination 201 along Route 206. En route Split Request 202 is received and Mass 203 and Mass 204 are made and sent to Destination 205.

FIG. 3 is an illustrative example of Vessel 303 carrying Mass 305 and leaving POL 301 to POD 302. Mass 305 is placed on Vessel 304 and transports Mass 305 directly to Destination 307 by skipping Distribution Center 306.

FIG. 4A is an illustrative example of a card graphic on a user interface, allowing rerouting during transit.

FIG. 4B is an illustrative example of a visual representation of a plurality of card graphics within a user interface of the disclosed systems and methods illustrated with a stack of card graphics.

### DETAILED DESCRIPTION

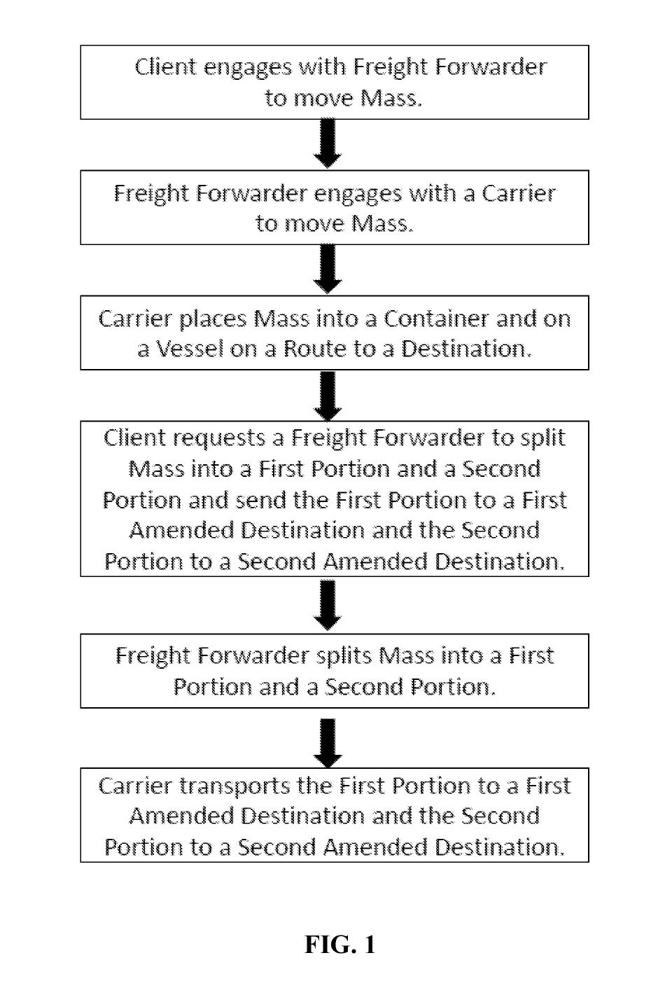

Disclosed herein are new systems and methods for quickly transporting mass from one location to another. In one embodiment, the systems and methods disclosed herein allow for dynamic rerouting of mass while the mass is moving or in transit. In one embodiment, the systems and methods disclosed herein allow for more efficient and cost-effective handling of shipments. In one example, mass is rerouted to a new destination without stopping at the original location, thus saving time and resources. FIG. 1 is an illustrative flow chart showing how the systems and methods disclosed herein can be used for rerouting mass.

Disclosed herein are new systems and methods for rerouting shipments after the mass being shipped has left the origin. In one embodiment, the shipment is rerouted to skip an originally intended stop, such as a distribution center. In one embodiment, the shipment is rerouted by directing it straight to a final consignee. In one embodiment, the systems and methods disclosed herein allow a user, e.g., a Client, to change the Destination of mass en route. In one embodiment, the systems and methods disclosed herein provide a Freight Forwarder with the ability to quickly change routes, intermediary stops, Destinations, and/or timelines for delivering mass.

Disclosed herein are new systems and methods for quicker consolidation of shipments. In one embodiment, the systems and methods disclosed herein aggregate shipments in a quicker manner. In one embodiment, the systems and methods disclosed herein aggregate shipments in an efficient manner. In one embodiment, the systems and methods disclosed herein aggregate shipments in a more cost-effective manner.

Disclosed herein are new systems and methods for quicker deconsolidation of shipments. In one embodiment, the systems and methods disclosed herein split shipments in a quicker manner. In one embodiment, the systems and methods disclosed herein split shipments in an efficient manner. In one embodiment, the systems and methods disclosed herein split shipments in a more cost-effective manner.

In one embodiment, a Freight Forwarder utilizes the systems and methods disclosed herein to reroute mass en route. In one embodiment, a Freight Forwarder utilizes the systems and methods disclosed herein to split a shipment into portions. In one embodiment, the individual portions of a mass are redirected to the same destination. In one embodiment, the individual portions of a mass are redirected to new destinations. In one embodiment, the individual portions of mass move along the same timeline of the original mass, e.g., one or more portions are delivered at the same time as the original shipment. In one embodiment, the individual portions of mass move along different timelines of the original mass, e.g., one or more portions are delivered at a different time as the original shipment.

Disclosed herein are new end to end systems and methods for visualizing shipments. In one embodiment, the systems and methods disclosed herein comprise a Physical, Tangible Display Means. In one embodiment, the Physical, Tangible Display Means provides a visual representation showing various levels of detail of a product, e.g., departure time, departure location, arrival time, number of products, etc. In one embodiment, the Physical, Tangible Display Means is presented on a screen, e.g., a mobile device, computer, screen, etc.

In one embodiment, visualizing shipments comprise using a graphical user interface, e.g., selecting options, using a touchscreen, using a mobile device, etc. In one embodiment, the graphical user interface comprises graphics, e.g., representations of a vessel, e.g., an airplane icon, a ship icon, a truck icon, etc.

Disclosed herein is a new Dynamic Routing System, comprising:

a First Client having a First Physical, Concrete and Tangible Object, said First Object having

a First Mass, a First Volume, a First Composition, and a First Starting Position;

a First Destination;

a First Route from the First Starting Position to the First Destination;

a Freight Forwarder;

a means for tracking the First Physical, Concrete and Tangible Object;

a movement of the First Physical, Concrete and Tangible Object along the First Route;

a subsequent Modification of the said First Route; and

a First Container.

As used herein, the term “Client” refers to an entity controlling mass, e.g., a person or business possessing an object needing to move from one position to another. In one embodiment, the Client is a human being. In one embodiment, the Client is a business. In one embodiment, the Client owns the mass. In one embodiment, the Client manages the mass. In one embodiment, the Client manages and/or cares for the mass. In one embodiment, the Client creates the mass. In one embodiment, the Client possesses physical control of the mass. In one embodiment, the Client needs to move the mass. In one embodiment, the Client engages with a Freight Forwarder to move the mass. In one embodiment, the Freight Forwarder engages with a Carrier to move the mass. In one embodiment, there is a First Client. In one embodiment, there is a Second Client. In one embodiment, there is a Third Client. In one embodiment, there are more than three Clients. In one embodiment, the Client transfers control of the mass to a Consignee, e.g., by transferring the mass to a Freight Forwarder, selling the mass to another person, and/or shipping the mass to another entity, etc. In one embodiment, the systems and methods disclosed herein allow a Client to quickly control the movement of the mass while the mass is moving, e.g., by changing the Destination of a mass.

As used herein, the term “Physical Concrete and Tangible Object” refers to an object made of matter and having mass. In one embodiment, the Physical Concrete and Tangible Object is a product, e.g., a commercial product, such as a shirt. In one embodiment, the Physical Concrete and Tangible Object is a collection or plurality of products. In one embodiment, the Physical Concrete and Tangible Object is a quantity, mass, weight, and/or volume of products requiring utilization of a full container, i.e., a full container load aka “FCL”. In one embodiment, the Physical Concrete and Tangible Object is a quantity, mass, weight, and/or volume of products requiring utilization of a less than container, i.e., a less than container load aka “LCL”. In one embodiment, the Physical Concrete and Tangible Object is a pallet of products, e.g., a pallet of clothing, a pallet of electronic devices, a pallet of hazardous materials, etc., which may (or may not) be further segmented and packaged, e.g., placed into boxes.

As used herein, the term “Mass” refers to the matter making up an object. In one embodiment, Mass is expressed in metric units, e.g., grams, kilograms, etc. In one embodiment, Mass is expressed in pounds. In one embodiment, there is a First Mass. In one embodiment, there is a Second Mass. In one embodiment, there is a Third Mass. In one embodiment, there are more than three Masses. In one embodiment, the Mass is a shirt. In one embodiment, the Mass is a shirt on a pallet. In one embodiment, the Mass is a shirt in a box.

As used herein, the term “Volume” refers to space within a three-dimensional coordinate system. In one embodiment, Volume is expressed in metric units, e.g., cm3, m3, etc. In one embodiment, the Volume is fixed. In one embodiment, the Volume changes. In one embodiment, there is a First Volume. In one embodiment, there is a Second Volume. In one embodiment, there is a Third Volume. In one embodiment, there are more than three Volumes. In one embodiment, the Volume is the space within a box measuring 18×14×12 inches, which may or may not be filled with one or more objects, e.g., shirts, cellular phones, books, etc. In one embodiment, the Volume is a space within a LCL. In one embodiment, the Volume is a space within a FCL.

Within the context of this disclosure, the term “volume” is also used to describe the amount of mass moving, e.g., volume of shipments, volume of products, etc., often per unit per time. In one embodiment, volume refers to the amount of mass on a pallet, e.g., boxes of shirts on a pallet.

As used herein, the term “Composition” refers to a material, materials, compound or compounds forming an object. In one embodiment, the Composition of the Physical Concrete and Tangible Object is a textile, such as cotton, e.g., cotton clothing. In one embodiment, the Composition of the Physical Concrete and Tangible Object is a food, e.g., a canned food product or beverage. In one embodiment, the Composition of the Physical Concrete and Tangible Object is a hazardous material, e.g., an aerosol, composed gas, a flammable material, corrosive, etc. In one embodiment, the Composition of the Physical Concrete and Tangible Object requires climate control, e.g., a perishable product in a cool environment.

As used herein, the term “Starting Position” refers to a physical geographical location in which an object is defined to originate within the transportation process managed by the systems and methods disclosed herein. In one embodiment, the Starting Position is expressed in longitude and latitude. In one embodiment, the Starting Position is a country. In one embodiment, the Starting Position is a city. In one embodiment, the Starting Position refers to the location of a Vessel, e.g., an airplane, a train, a truck, a ship, etc., e.g., at a port, a yard, a distribution center, factory, etc., on which a Physical Concrete and Tangible Object begins a leg of its voyage. In one embodiment, the Starting Position is the beginning location of an ocean transportation leg, e.g., a port in Shanghai, Los Angeles, or Singapore. In one embodiment, the Starting Position is a Port of Loading (POL). In one embodiment, the Starting Position is the site of manufacturing of mass, i.e., the location from which the mass was made, i.e., the place where the mass came into existence.

As used herein, the term “Port of Loading” aka “POL” refers to the location in which a Physical Concrete and Tangible Object is placed into a Container, Vessel, or other apparatus. In one embodiment, the term “Port of Loading” refers to the “Place of Receipt,” for example where the cargo is loaded into a container. In one embodiment, the term “Port of Loading” refers to the place at which a container is loaded onto a vessel. In one embodiment, a Port of Loading is a reference point for establishing where the Physical Concrete and Tangible Object moves forward. In one embodiment, the Port of Loading is the same location as the Starting Position. In one embodiment, the Port of Loading is the same location as the First Destination. In one embodiment, the Port of Loading is a port in Shanghai. In one embodiment, the Port of Loading is a port in Thailand. In one embodiment, the Port of Loading is a port in Los Angeles and the Port of Discharge is a port in Shanghai. In one embodiment, the Port of Loading is a port in Hong Kong and the Port of Discharge is a port in Oakland. In one embodiment, a Freight Forwarder requests a Carrier to move mass. In one embodiment, a Carrier transports mass from a Port of Loading to a Port of Discharge with a Vessel, e.g., a ship, an airplane, a truck, etc.

As used herein, the term “Destination” refers to a physical, geographical location to which an object is moved. In one embodiment, the Destination is a location at which mass is intended to remain stationary after completing the transportation as requested by a Client. In one embodiment, the Destination is one of a series of Destination points. In one embodiment, the Destination is the last of a series of points on a Route. In one embodiment, the movement of mass comprises a First Destination. In one embodiment, the movement of mass comprises a Second Destination. In one embodiment, the movement of mass comprises a Third Destination. In one embodiment, the movement of mass comprises more than three Destinations. In one embodiment, the Destination is Seattle. In one embodiment, the Destination is Amsterdam. In one embodiment, the Destination is New York. In one embodiment, the Destination is Tuticorin. In one embodiment, the Destination is the intended final location of a mass, i.e., the arrival location of a mass within a transportation process or contract. In one embodiment, the Destination is a distribution center. In one embodiment, the Destination is a Port of Discharge (“POD”).

As used herein, the term “Route” refers to a path through which mass moves from one location to another. In one embodiment, the Route is the movement of mass from a Starting Position to a Destination. In one embodiment, the Route comprises multiple points through which mass is moved from a Starting Position to a Destination. For example, a truck moving mass from a Port of Discharge to multiple retail stores. In one embodiment, the Route is a continuous path through which mass moves. In one embodiment, the Route is divided into segments which can be taken together to form a path from one point to another. In one embodiment, the Route comprises a series of two or more points through which mass moves. In one embodiment, the Route is measured in distance, e.g., miles, kilometers, etc. In one embodiment, the Route is measured in time, e.g., days, hours, minutes, etc. In one embodiment, the Route is measured in distance and time. In one embodiment, the Route comprises points (e.g., concrete physical locations) between a port in Shanghai and a port in Los Angeles through which mass moves. For example, a Freight Forwarder uses the systems and methods disclosed herein to define a Route between two Destinations for moving a Client's mass. In another example, a Client changes the Destination and the Freight Forwarder changes the Route to an Amended Destination with the systems and methods disclosed herein.

As used herein, the term “Freight Forwarder” refers to an entity facilitating the movement of mass. In one embodiment, the Freight Forwarder engages in a contractual relationship with a Client to move mass for all or part of a Route. In one embodiment, the Freight Forwarder engages in a contractual relationship with a Carrier to move mass for all or part of a Route. In one embodiment, the Freight Forwarder warrants possession of mass. In one embodiment, the Freight Forwarder receives a request from a Client to change the movement of mass, e.g., changing the Destination, splitting the mass, etc. In one embodiment, the Freight Forwarder utilizes the methods and systems disclosed herein to accomplish a Client's request, e.g., contacting a Carrier to split mass for shipment to different Destinations.

As used herein, the term “Carrier” refers to an entity capable of moving substantial quantities of mass. In one embodiment, the Carrier is a business entity. In one embodiment, the Carrier controls a Vessel, e.g., a ship, used for moving mass. In one embodiment, the Carrier controls more than one Vessel for moving mass. In one embodiment, the Carrier possesses and sells space aboard one or more Vessels.

As used herein, the term “Vessel” refers to a machine for moving mass across a distance and/or geographical barrier. In one embodiment, the Vessel is a vehicle. In one embodiment, the Vessel is a ship, e.g., a container ship. In one embodiment, the Vessel is an airplane, e.g., a cargo plane. In one embodiment, the Vessel is a train. In one embodiment, the Vessel is a truck. In one embodiment, the systems and methods disclosed herein comprise a First Vessel. In one embodiment, the systems and methods disclosed herein comprise a Second Vessel. In one embodiment, the systems and methods disclosed herein comprise a Third Vessel. In one embodiment, the systems and methods disclosed herein comprise more than three Vessels.

As used herein, the term “Port of Discharge” aka “POD” refers to a location where mass is removed from a Carrier's authority. In one embodiment, the Port of Discharge is the same location as the Destination. In one embodiment, the Port of Discharge is the location where mass is removed from a container. In one embodiment, the Port of Discharge is the location where a Consignee takes control of mass. In one embodiment, the Port of Discharge is a port, for example a port in Long Beach, N.Y., Oakland, etc. In one embodiment, the Port of Discharge is where mass is removed from a Container. In one embodiment, the Port of Discharge is a place where a Client agrees to send or receive mass. In one embodiment, the Port of Discharge is where a consignee is located.

As used herein, the term “Twenty-Foot-Equivalent Unit”, or “TEU”, refers to a unit of capacity of a container, i.e., a 20′ container.

As used herein, the term “Forty-Foot-Equivalent Unit”, or “FEU”, refers to a unit of capacity of a container, i.e., a 40′ container. In one embodiment, the FEU is two 20′ containers. In one embodiment, the FEU is a 40′ container. In one embodiment, the FEU is a 40′ High Cube container.

As used herein, the term “means for tracking” refers to something having the ability to follow and determine the geographic position and/or movement of an object. In one embodiment, the means for tracking comprises a Global Positioning System (GPS) device. In one embodiment, the GPS is affixed on a Vessel. In one embodiment, the GPS is affixed on an airplane. In one embodiment, the means for tracking comprises a GPS device positioned in or on a Container. In one embodiment, the means for tracking comprises a device capable of following the position of an Object as said Object moves, e.g., along a path, e.g., shipping Route, truck route, or a flight path. In one embodiment, the means for tracking comprises a map. In one embodiment, the means for tracking comprises coordinates, e.g., longitude and latitude, addresses, etc. In one embodiment, the means for tracking comprises a device capable or system capable of following the Object's position in real time. In one embodiment, the systems disclosed herein automatically log and record the path, including location, and time of an Object. In one embodiment, the means for tracking comprise a map.

As used herein, the term “movement” refers to a change or displacement from one position to another. In one embodiment, the movement comprises a mass physically moving by the act of another device, machine, entity, or thing, e.g., a Carrier using an airplane for moving a pallet of mass from one Destination to another Destination. In one embodiment, the systems and methods disclosed herein automatically track the movement of a particular mass. In one embodiment, the movement of mass comprises changing a Route, e.g., a movement of mass from Shanghai to a distribution center in San Francisco changing to a movement of mass from Shanghai to a retail store in Los Angeles.

As used herein, the term “Subsequent Modification” refers to a change to the intended path of a Physical Concrete and Tangible Object. In one embodiment, the systems and methods disclosed herein automatically make a Subsequent Modification in the Route of a Physical Concrete and Tangible Object. In one embodiment, a Client uses the systems and methods disclosed herein to request a Subsequent Modification. In one embodiment, the Subsequent Modification comprises splitting a portion of mass, e.g., dividing a FCL into two or more LCLs. In one embodiment, the Subsequent Modification comprises dividing two FCLs into portions. In one embodiment, the Subsequent Modification comprises a change in Destination, e.g., a Container shipped from Amsterdam to New York, has the Destination changed after the Container leaves Amsterdam, thereby rerouting the container to Boston. In one embodiment, the Subsequent Modification comprises changes to two or more Destinations. In one example, a pallet of shirts originally routed from Taiwan to Los Angeles may be split into two portions during transit, with one sent to Long Beach and the other sent to San Diego. In one embodiment, the Subsequent Modification is a change from a distribution center to a retailer location, for example a clothing store. In one embodiment, the Subsequent Modification is a change from a distribution center to the individual locations of each of several retailers.

In one embodiment, the systems and methods disclosed herein comprise a Second Client having a Second Physical Concrete and Tangible Object, said Second Object having a Second Mass, a Second Volume, and a Second Starting Position.

In one embodiment, the systems and methods disclosed herein comprise a Second Destination.

In one embodiment, the systems and methods disclosed herein comprise a Second Route from the Second Starting Position to the Second Destination.

In one embodiment, the systems and methods disclosed herein comprise a Second Physical Concrete and Tangible Object in the First Container.

In one embodiment of the systems and methods disclosed herein, the Subsequent Modification of the said First Route comprises changing the First Destination.

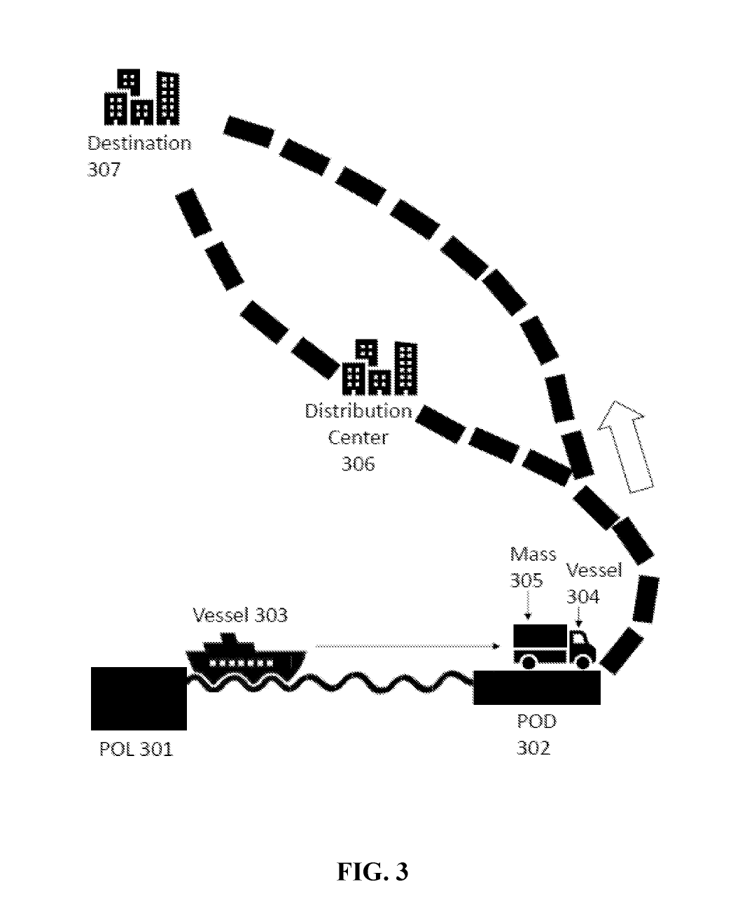

As used herein, the term “changing the First Destination” refers to altering the intended path of a mass by modifying a point on that point. In one embodiment, changing the First Destination comprises using the systems and methods disclosed herein, e.g., a Client using a graphical user interface, e.g., a mobile device. In one embodiment, changing the First Destination comprises requesting a different Destination from a First Client. In one embodiment, changing the First Destination comprises using the systems and methods disclosed herein to accept input from a Freight Forwarder, e.g., a Freight Forwarder using a graphical user interface, e.g., a screen displaying options. In one embodiment, changing the First Destination comprises altering the Route of a Physical Concrete and Tangible Object from a First Destination to an Amended Destination. FIG. 3 is an illustrative example of Vessel 303 carrying Mass 305 and leaving POL 301 to POD 302. Mass 305 is placed on Vessel 304 and transports Mass 305 directly to Destination 307 by skipping Distribution Center 306.

In one embodiment of the systems and methods disclosed herein, the Subsequent Modification of the First Route comprises:

splitting the First Mass into a First Portion and a Second Portion;

moving the First Portion along a Third Route; and

moving the Second Portion along a Fourth Route.

As used herein, the term “splitting” refers to dividing and/or separating a mass into individual pieces. In one embodiment, splitting comprises moving mass from a First Container into a Second Container. In one embodiment, splitting comprises separating a pallet from a LCL. In one embodiment, splitting comprises separating a box from a pallet.

As used herein, the term “portion” refers to a piece of a larger set or whole. In one embodiment, the portion is a pallet, e.g., a pallet or pallets within a container or containers. In one embodiment, the portion is a box, e.g., a box that is on a pallet with a larger collection of boxes. In one embodiment, the portion is an item from inside of a box. In one embodiment, a Freight Forwarder utilizes the systems and methods disclosed herein to create portions. In one embodiment, the portion is sent to a different location than the larger subset, e.g., a box from a pallet is sent to an Amended Destination and the remainder of the pallet is sent to a First Destination. In one embodiment, a First Portion moves along a Third Route and a Second Portion moves along a Fourth Route.

As used herein, the term “moving” refers to transporting and/or transferring. In one embodiment, moving comprises transferring mass from one Route to another. In one example, moving a Physical Concrete and Tangible Object from a First Destination to a Second Destination, e.g., a mass moving from a Starting Position of Shanghai to a First Destination of Chicago changing en route to an Amended Destination of New York.

In one embodiment, a Freight Forwarder uses the systems and methods disclosed herein to accomplish moving an Object, for example an Object that a Client wants moved to a Second Destination instead of a First Destination. In one embodiment, moving comprises splitting a mass into portions and sending the individual portions to one or more Amended Destinations, e.g., moving a First Portion along a Third Route and moving a Second Portion along a Fourth Route.

In one embodiment of the systems and methods disclosed herein, the Third Route is different from the Fourth Route. In one embodiment of the systems and methods disclosed herein, the Third Route is the same as the First Route.

In one embodiment of the systems and methods disclosed herein, the modification of the First Route comprises an Amended Destination.

As used herein, the term “Amended Destination” refers to a different physical, geographical location than intended for an object. In one embodiment, a Freight Forwarder utilizes the systems and methods disclosed herein to change the movement of a mass from a First Destination to an Amended Destination. In one embodiment, a First Client requests an Amended Destination to a Freight Forwarder. In one embodiment, the Freight Forwarder relays the Amended Destination to a Carrier. In one embodiment, the Carrier moves a mass from a First Destination to the Amended Destination. In one embodiment, the Amended Destination is a Second Destination. In one embodiment, the Physical Concrete and Tangible Object, e.g., a FCL, is sent to an Amended Destination, e.g., the location of a wholesale retailer, instead of the originally intended Destination. In one embodiment, a portion of the Physical Concrete and Tangible Object, e.g., a box from a pallet is sent to an Amended Destination, e.g., the location of a retailer, instead of the originally intended Destination.

In one embodiment, the systems disclosed herein comprise a Physical, Tangible Display Means. As used herein, the term “Physical, Tangible Display Means” refers to a visual medium for presenting information. In one embodiment, the Physical, Tangible Display Means comprises a graphical user interface. In one embodiment, the Physical, Tangible Display Means comprises a screen. In one embodiment, the Physical, Tangible Display Means comprises a computer. In one embodiment, the Physical, Tangible Display Means comprises a mobile device. In one embodiment, the Physical, Tangible Display Means comprises paper, e.g., a facsimile or print out.

In one embodiment, the Physical, Tangible Display Means presents a visual representation of a Port of Loading. In one embodiment, the Physical, Tangible Display Means presents a visual representation of a Port of Destination. In one embodiment, the Physical, Tangible Display Means presents a visual representation of an Amended Destination. In one embodiment, the Physical, Tangible Display Means presents a visual representation of a movement of a mass from a First Destination to an Amended Destination. In one embodiment, the Physical, Tangible Display Means presents a visual representation of a First Route. In one embodiment, the Physical, Tangible Display Means presents a visual representation of a Vessel.

In one embodiment, the Physical, Tangible Display Means presents representations of the status of a delivery, e.g., pie charts, graphs, etc.

In one embodiment, the Physical, Tangible Display Means presents a visual representation of availability of space, for example by using a color scheme.

In one embodiment of the systems disclosed herein, the Physical, Tangible Display Means comprises a Visible Representation of the First Route.

As used herein, the term “Visible Representation” refers to a graphical portrayal of a path. In one embodiment, the Visible Representation comprises graphics, e.g., symbols and markings representing roads, flight paths, Routes, Vessels, etc. In one embodiment, the Visible Representation is presented with a graphical user interface. In one embodiment, the Visible Representation presents graphical illustrations of measurements, e.g., distance, weight, time, etc. In one embodiment, the Visible Representation comprises one or more graphics or symbolic markers, e.g., an “X” representing a Destination or an arrow pointing to a Destination.

In one embodiment of the systems disclosed herein, the Visual Representation of the First Route presents an option for accessing Documentation chosen from an Origin, Destination, Carrier, Identification Number, or Composition.

As used herein, the term “Documentation” refers to a record or memorization. In one embodiment, the Documentation is a record of an event and/or thing. In one embodiment, the systems disclosed herein automatically create the Documentation. In one embodiment, the Documentation comprises a certification of a mass existing in a particular time, place, and/or condition. In one embodiment, the Documentation comprises a record of a mass leaving an Origin. In one embodiment, a First Client creates the Documentation. In one embodiment, the Documentation is given to a Freight Forwarder. In one embodiment, the Freight Forwarder shares the Documentation with a Carrier via the systems and methods disclosed herein.

As used herein, the term “Identification Number” refers to a sequence of characters specifying a particular thing, such as one thing within a larger group of things. In one embodiment, the Identification Number comprises Arabic numerals. In one embodiment, the Identification Number comprises Roman numerals. In one embodiment, the Identification Number comprises symbols, e.g., lines, dashes, periods, parentheses, etc. In one embodiment, the Identification Number comprises letters. In one embodiment, the Identification Number is created by a First Client. In one embodiment, the Identification Number is modified, e.g., using the systems and methods disclosed herein. In one embodiment, the Identification Number specifies a Physical Concrete and Tangible Object, e.g., textiles, electronic devices, food products, etc. In one embodiment, the Identification Number specifies a pallet. In one embodiment, the Identification Number specifies a Container.

In one embodiment of the systems and methods disclosed herein, the Visual Representation of the First Route comprises a graphical representation of a Product Attribute.

As used herein, the term “Product Attribute” refers to a trait related to a mass. In one embodiment, the Product Attribute is a physical trait, e.g., number of units, shape, mass, weight, volume, etc. In one embodiment, the Product Attribute is created by a Client, e.g., shape, reactivity, custom number, etc. In one embodiment, the Product Attribute is intrinsic to the mass, e.g., reactivity, shelf life, odor, etc. In one embodiment, the Product Attribute marks a difference between masses, e.g., one mass is a piece of clothing and another mass is an electronic device. In one embodiment, the Product Attribute is a condition, e.g., storage at a specific temperature, hazmat requirements, etc. In one embodiment, the systems and methods disclosed herein log all Product Attributes. In one embodiment, a user of the systems and methods disclosed herein selects a Product Attribute to be presented, e.g., using a graphical user interface, e.g., selecting a Product Attribute from a screen.

In one embodiment of the systems disclosed herein, the Product Attribute is chosen from weight, number of pieces, or SKU.

As used herein, the term “weight” refers to a unit of measurement describing the force of Earth's gravity acting on an object. In one embodiment, weight is expressed in pounds. In one embodiment, weight is expressed in ounces.

Within the context of this disclosure, weight also refers to mass. In one embodiment, weight is expressed in grams. In one embodiment, weight is expressed in kilograms.

As used herein, the term “number of pieces” refers to the amount of units making up a particular mass. In one embodiment, the number of pieces is the amount of mass moving from one location to another, e.g., commercial products, electronic devices, food products, etc. In one embodiment, the number of pieces refers to the individual products within a larger unit of measurement, e.g., the number of shirts within a box, the number of boxes on a pallet, etc. In one embodiment, the number of pieces is placed on a pallet, e.g., a pallet of clothing, a pallet of electronic devices, a pallet of hazardous materials, etc., which may (or may not) be further individually segmented and packaged, e.g., placed into boxes. In one embodiment, the number of pieces refers to a unit of storage, e.g., a container, a box, a pallet, etc. In one embodiment, the systems and methods disclosed herein automatically record the number of pieces. In one embodiment, the number of pieces are split and rerouted to an Amended Destination.

As used herein, the term “SKU” or “Stock Keeping Unit” refers to an identifier assigned to a distinct type of item, such as a product or service, and all attributes associated with the item type, distinguish it from the other item types. In one embodiment, the SKU refers to a product. In one embodiment, the SKU includes an attribute chosen from manufacturer, description, material, size, color, packaging, warranty terms, etc. In one embodiment, the SKU refers to a unique identifier, e.g., a sequence of numbers and/or letters. In one embodiment, the First Client assigns a SKU to a Physical Concrete and Tangible Object. In one embodiment, the systems and methods disclosed herein automatically log the SKU. In one embodiment, the systems and methods disclosed herein track the movement of an item by referencing the SKU. In one embodiment, a collection of Physical Concrete and Tangible Objects all have the same SKU, e.g., a collection of phones in a box containing only like phones. In one embodiment, a collection of Physical Concrete and Tangible Objects all have different SKUs, e.g., a collection of phones in a box of items where each item has a different SKU.

In one embodiment of the systems disclosed herein, the Visual Representation of the First Route comprises a map.

As used herein, the term “map” refers to a diagrammatic representation of an area of land or water showing physical features, e.g., cities, roads, etc. In one embodiment, the map is automatically generated by the systems and methods disclosed herein. In one embodiment, the map is a digital map. In one embodiment, the map comprises graphics, e.g., icons representing a plane, ship, or truck moving from one area to another. In one embodiment, the map comprises symbols, e.g., a circle denoting a Destination. In one embodiment, a user of the systems and methods disclosed herein manipulates the map, e.g., moving symbols to create a new path of a mass.

In one embodiment of the systems disclosed herein, the Visual Representation of the First Route comprises a card graphic. In one embodiment of the systems disclosed herein, the Visual Representation of the First Route comprises a plurality of card graphics.

As used herein, the term “card graphic” refers to a representation of information within a perimeter. In one embodiment, the card graphic comprises a departure day of mass. In one embodiment, the card graphic comprises the location of a First Destination. In one embodiment, the card graphic comprises the identity of a First Client. In one embodiment, the card graphic is presented on a tangible medium, e.g., paper, plastic, etc. In one embodiment, the card graphic is presented a visual medium, e.g., a screen, e.g., on a mobile device. In one embodiment, the card graphic comprises a Product Attribute, e.g., number of items, manufacturer, date of departure, etc. In one embodiment, the card graphic is created by the systems and methods disclosed herein. In one embodiment, a Freight Forwarder modifies the card graphic, e.g., changing the information presented, e.g., changing the First Destination to an Amended Destination with the systems and methods disclosed herein. In one embodiment, the card graphic comprises a reference to the number of cards generated from the original card graphic. In one embodiment, the card graphic is split into a plurality of card graphics, e.g., a mass is divided and sent to multiple Amended Destinations and a card graphic is generated for each Amended Destination.

In one example, a mass moving from Hong Kong to New York is split into two portions and one portion is sent to Boston and the other is sent to Philadelphia. The systems and methods disclosed herein produce two card graphics representing the mass portion and their Amended Destination and are stored with the original card graphic.

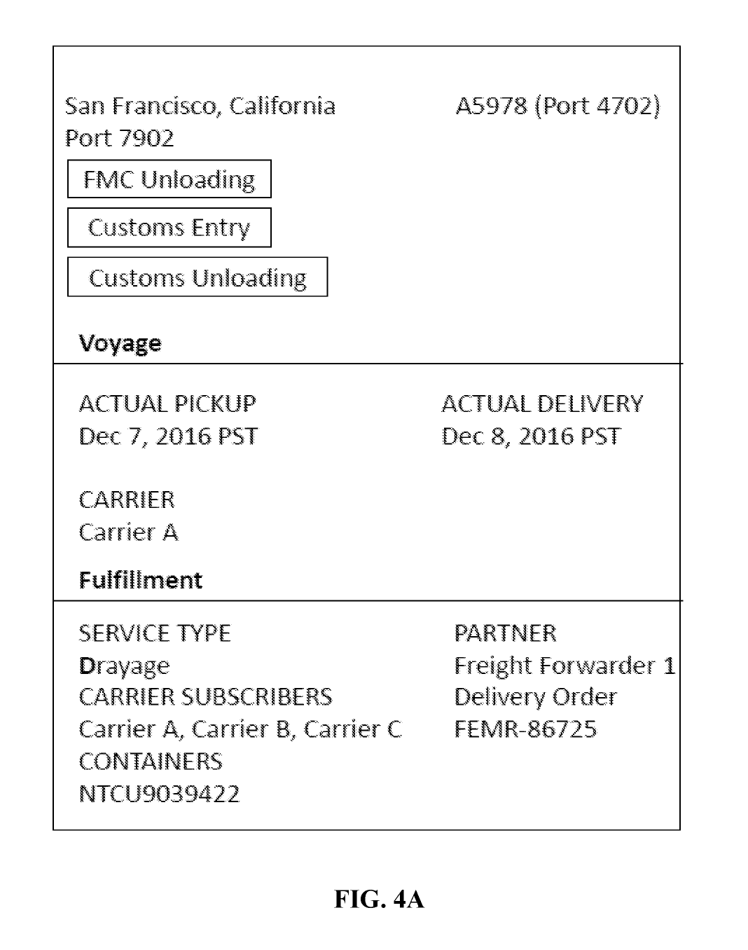

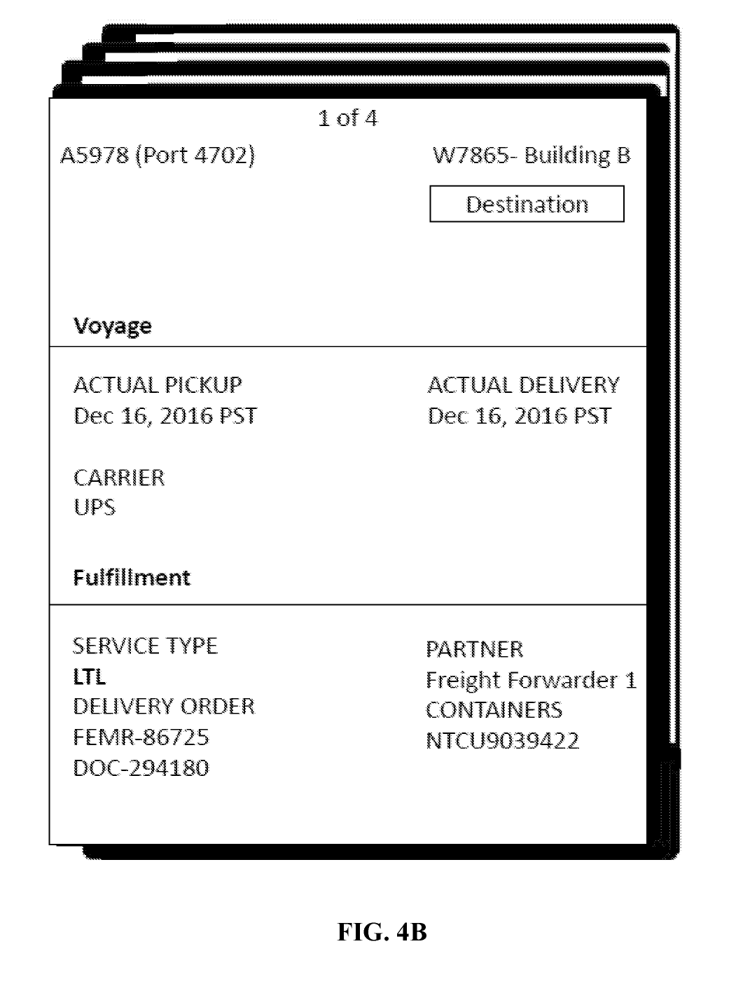

FIG. 4A is an illustrative example of a card graphic on a user interface, allowing rerouting during transit.

FIG. 4B is an illustrative example of a visual representation of a plurality of card graphics within a user interface of the disclosed systems and methods illustrated with a stack of card graphics.

In one embodiment of the systems disclosed herein, the Visual Representation of the First Route comprises a Cargo Ruler.

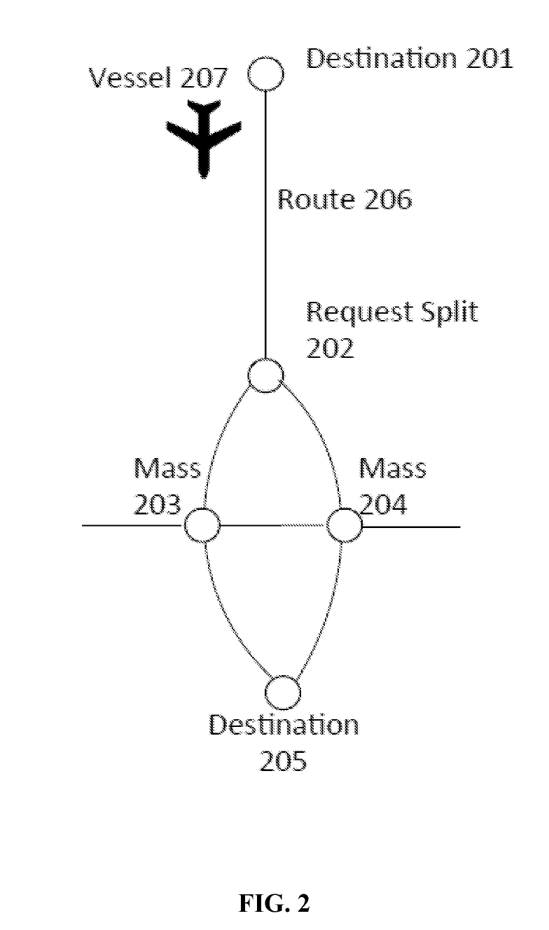

As used herein, the term “Cargo Ruler” refers to a representation of a Route of mass. In one embodiment, the Cargo Ruler represents the splitting of mass by creating new Routes and Destinations. In one embodiment, the systems disclosed herein automatically generate the Cargo Ruler. In one embodiment, the Cargo Ruler comprises an axis, e.g., x, y, and z. In one embodiment, the Cargo Ruler comprises a series of locations, e.g., one or more Destinations, e.g., Shanghai and San Francisco. In one embodiment, the Cargo Ruler comprises a First Route and a Second Route. In one embodiment, the Cargo Ruler comprises the number of Deliveries on a Route. In one embodiment, the Cargo Ruler comprises a number of pallets, e.g., a total number of pallets and the division of the pallets. In one embodiment, the Cargo Ruler comprises moveable graphics, e.g., lines denoting the direction of mass. FIG. 2 is an illustrative example of a Cargo Ruler as presented on a display means presenting Vessel 207 leaving Destination 201 along Route 206. En route Split Request 202 is received and Mass 203 and Mass 204 are made and sent to Destination 205.

In one embodiment of the systems disclosed herein, the Visual Representation of the First Route is a directional graph.

As used herein, the term “directional graph” refers to a visual representation of vertices connected by edges, where the edges have a direction associated with them. In one embodiment, the directional graph comprises arrows. In one embodiment, the directional graph comprises an axis, e.g., x, y, and z coordinates. In one embodiment, the directional graph comprises representations of measurements, e.g., distance, velocity, time etc. In one embodiment, the directional graph provides a visual representation of the movement of mass. In one embodiment, the directional graph is presented on a graphical user interface. In one embodiment, the directional graph comprises graphics, e.g., icons and symbols representing an airplane, ship, truck, and/or train. In one embodiment, the directional graph comprises representations of motion, e.g., a truck moving from one path to another through the use of arrows and dotted lines. In one embodiment, the systems and methods disclosed herein automatically generate a directional graph. In one embodiment, a user of the systems and methods disclosed herein inputs data, e.g., a user adds a new Destination and the directional graph generates a new representation. In one embodiment, the systems and methods disclosed herein prompt a user to input data, e.g., confirmation of a changed Destination.

Although the present invention herein has been described with reference to various exemplary embodiments, it is to be understood that these embodiments are merely illustrative of the principles and applications of the present invention. Those having skill in the art would recognize that various modifications to the exemplary embodiments may be made, without departing from the scope of the invention.

Moreover, it should be understood that various features and/or characteristics of differing embodiments herein may be combined with one another. It is therefore to be understood that numerous modifications may be made to the illustrative embodiments and that other arrangements may be devised without departing from the scope of the invention.

Furthermore, other embodiments of the invention will be apparent to those skilled in the art from consideration of the specification and practice of the invention disclosed herein. It is intended that the specification and examples be considered as exemplary only, with a scope and spirit being indicated by the claims.

Finally, it is noted that, as used in this specification and the appended claims, the singular forms “a,” “an,” and “the,” include plural referents unless expressly and unequivocally limited to one referent, and vice versa. As used herein, the term “include” or “comprising” and its grammatical variants are intended to be non-limiting, such that recitation of an item or items is not to the exclusion of other like items that can be substituted or added to the recited item(s).

What is claimed is:

1. A Dynamic Routing System, comprising:
a First Client having a First Physical Concrete and Tangible Object, said First Object having a First Mass, a First Volume, a First Composition, and a First Starting Position;
a First Destination;
a First Route from the First Starting Position to the First Destination;
a Freight Forwarder;
a means for tracking the First Physical Concrete and Tangible Object;
a movement of the First Physical Concrete and Tangible Object along the First Route;
a Subsequent Modification of the said First Route; and
a First Container.

2. The Dynamic Routing System of claim 1, comprising a Second Client having a Second Physical Concrete and Tangible Object, said Second Object having a Second Mass, a Second Volume, and a Second Starting Position.

3. The Dynamic Routing System of claim 1, comprising a Second Destination.

4. The Dynamic Routing System of claim 3, comprising a Second Route from the Second Starting Position to the Second Destination.

5. The Dynamic Routing System of claim 4, comprising the Second Physical Concrete and Tangible Object in the First Container.

6. The Dynamic Routing System of claim 1, wherein the Subsequent Modification of the First Route comprises changing the First Destination.

7. The Dynamic Routing System of claim 1, wherein the Subsequent Modification of the First Route comprises:
splitting the First Mass into a First Portion and a Second Portion;
moving the First Portion along a Third Route; and
moving the Second Portion along a Fourth Route.

8. The Dynamic Routing System of claim 1, wherein the Third Route is different from the Fourth Route.

9. The Dynamic Routing System of claim 1, wherein the Third Route is the same as the First Route.

10. The Dynamic Routing System of claim 1, wherein the Subsequent Modification of the First Route comprises an Amended Destination.

11. The Dynamic Routing System of claim 1, comprising a Physical, Tangible Display Means.

12. The Dynamic Routing System of claim 11, wherein the Physical, Tangible Display Means comprises a Visible Representation of the First Route.

13. The Dynamic Routing System of claim 11, wherein the Visual Representation of the First Route comprises Documentation chosen from an Origin, First Destination, Carrier, Identification Number, or Composition.

14. The Dynamic Routing System of claim 11, wherein the Visual Representation of the First Route comprises a Product Attribute.

15. The Dynamic Routing System of claim 14, wherein the Product Attribute is chosen from weight, number of pieces, or SKU.

16. The Dynamic Routing System of claim 11, wherein the Visual Representation of the First Route comprises a map.

17. The Dynamic Routing System of claim 16, wherein the Visual Representation of the First Route comprises a card graphic.

18. The Dynamic Routing System of claim 1, wherein the Visual Representation of the First Route comprises a plurality of card graphics.

19. The Dynamic Routing System of claim 1, wherein the Visual Representation of the First Route comprises a Cargo Ruler.

20. The Dynamic Routing System of claim 1, wherein the Visual Representation of the First Route is a directional graph.
